(19) United States
(12) Patent Application Publication
(10) Pub. No.: US 2026/0295516 A1
(43) Pub. Date: Oct. 1, 2026

(54) METHOD FOR REMOVING MOISTURE AT HIGH EFFICIENCY BY MEMBRANE-BASED CARBON DIOXIDE CAPTURE SYSTEM AND APPARATUS THEREFOR

(71) Applicants: Hyundai Motor Company, Seoul (KR); Kia Corporation, Seoul (KR)

(72) Inventor: Woo Ram Kang, Hwaseong-Si (KR)

(21) Appl. No.: 19/336,667

(22) Filed: Sep. 23, 2025

(30) Foreign Application Priority Data
Mar. 28, 2025 (KR) 10-2025-0040086

(51) Int. Cl. B01D 53/26; B01D 53/22; B01D 53/92

(52) U.S. Cl. CPC B01D 53/261; B01D 53/22; B01D 53/92; B01D 2257/504; B01D 2259/40084

(57) ABSTRACT

A method for removing moisture in a membrane-based carbon dioxide capture system may be performed by one or more components of the membrane-based carbon dioxide capture system. The method may include producing capture gas and residual gas by separating and capturing exhaust gas through a membrane, supplying the residual gas as a purging gas to a moisture removal bed to desorb moisture, and then discharging the desorbed moisture and the residual gas left in the moisture removal bed to an outside of a system by opening a purging gas vent line valve, filling the moisture removal bed with the capture gas by controlling a purging gas switching valve based on completion of desorption of the moisture, and locking the purging gas vent line valve based on that the moisture removal bed has been filled with the capture gas.

### CROSS-REFERENCE TO RELATED APPLICATION

This application claims the benefit of priority to Korean Patent Application No. 10-2025-0040086, filed in the Korean Intellectual Property Office on Mar. 28, 2025, the entire contents of which are incorporated herein by reference.

### TECHNICAL FIELD

The present disclosure relates to a carbon dioxide capture system, and more particularly, to a technology for solving an efficiency limitation of a moisture removal process, among pre-processing processes, in a carbon dioxide capture system utilizing a membrane.

### BACKGROUND

Exhaust gas from high-temperature combustion, which may be discharged in various industrial processes. Such exhaust gas may be mainly composed of carbon dioxide, nitrogen, oxygen, moisture, and the like.

Membrane technologies may be used for capturing carbon dioxide in exhaust gas. For example, a membrane may allow only carbon dioxide (e.g., a greenhouse gas) in the exhaust gas to pass, thereby separating the carbon dioxide from the rest of the exhaust gas by using differences in physical or chemical properties of carbon dioxide from other gas molecules.

Compared to a wet method, the membrane technology may not require a separate wet top, which may reduce a space utilization in a factory. Also, the membrane technology may not use a high temperature, which may improve energy efficient.

A carbon capture and storage (CCUS) technology may be a technology of separating carbon dioxide from a gas mixture, and capturing and storing the carbon dioxide. CCUS technology may be useful as a decarbonization technology because it not only contributes to energy reduction and carbon neutrality but also helps in satisfying greenhouse gas emission regulations and secures carbon emission rights.

Carbon dioxide captured separately from the exhaust gas may be utilized in other applications, such as dry ice, and/or may be buried deep underground.

When/if carbon dioxide is captured using a membrane, the moisture contained in the exhaust gas may be condensed on the surface of the membrane and obstruct permeation of carbon gas through the membrane. The moisture condensate may cause problems, such as corrosion of equipment and/or freezing (e.g., in the winter season.

The matters described in this Background section are only for enhancement of understanding of the background of the disclosure, and should not be taken as acknowledgement that they correspond to prior art already known to those skilled in the art.

### SUMMARY

The following summary presents a simplified summary of certain features. The summary is not an extensive overview and is not intended to identify key or critical elements.

Systems, apparatuses/devices, and methods are described for removing moisture from a carbon dioxide capture system. A method performed by a carbon dioxide capture system may comprise: separating, via a membrane of the carbon dioxide capture system, exhaust gas into a capture gas and a residual gas, wherein the capture gas comprises carbon dioxide removed via the membrane from the exhaust gas, and the residual gas comprises a residual of the exhaust gas; supplying, to a moisture removal bed of the carbon dioxide capture system, the residual gas as a purging gas to desorb moisture from the moisture removal bed; discharging, from the moisture removal bed and to an outside of the carbon dioxide capture system by opening a purging gas vent line valve of the carbon dioxide capture system, moisture desorbed from the moisture removal bed and a portion of the residual gas in the moisture removal bed; based on desorption of moisture from the moisture removal bed being completed, filling, by controlling a purging gas switching valve, the moisture removal bed with the capture gas; and locking, based on the moisture removal bed being filled with the capture gas, the purging gas vent line valve.

A computing device associated with a carbon dioxide capture system may comprise a processor configured to execute instructions; and a memory configured to store the instructions, wherein the instructions, when executed by the processor, are configured to cause the carbon dioxide capture system to: separate, via a membrane of the carbon dioxide capture system, exhaust gas into a capture gas and a residual gas, wherein the capture gas comprises carbon dioxide removed via the membrane from the exhaust gas, and the residual gas comprises a residual of the exhaust gas, supply, to a moisture removal bed of the carbon dioxide capture system, the residual gas as a purging gas to desorb moisture from the moisture removal bed, discharge, from the moisture removal bed and to an outside of the carbon dioxide capture system by opening a purging gas vent line valve of the carbon dioxide capture system, moisture desorbed form the moisture removal bed and a portion of the residual gas in the moisture removal bed, based on desorption of moisture from the moisture removal bed being completed, fill, by controlling a purging gas switching valve, the moisture removal bed with the capture gas, and lock based on the moisture removal bed being filled with the capture gas, the purging gas vent line valve.

A carbon dioxide capture system may comprise a membrane configured to selectively allow passage of carbon dioxide; a moisture removal bed configured to adsorb moisture from a gas; a purging gas vent line valve configured to open or lock a purging gas vent line; a purging gas switching valve configured to switch a source of gas to the moisture removal bed; and control circuitry. The control circuitry may be configured to control the carbon dioxide capture system to: separate, via the membrane, exhaust gas into a capture gas and a residual gas, wherein the capture gas comprises carbon dioxide removed from the exhaust gas, and the residual gas comprises a residual of the exhaust gas, supply, to the moisture removal bed, the residual gas as a purging gas to desorb moisture from the moisture removal bed; discharge, from the moisture removal bed by opening the purging gas vent line valve, moisture desorbed form the moisture removal bed and a portion of the residual gas in the moisture removal bed, based on a determination that desorption of moisture from the moisture removal bed being completed, fill, by controlling the purging gas switching valve, the moisture removal bed with the capture gas, and lock, based on the moisture removal bed being filled with the capture gas, the purging gas vent line valve.

These and other features and advantages are described in greater detail below.

### BRIEF DESCRIPTION OF THE DRAWINGS

The above and other objects, features and advantages of the present disclosure will be more apparent from the following detailed description taken in conjunction with the accompanying drawings:

FIG. 1 is a view illustrating a schematic configuration of a membrane-based carbon dioxide capture system according to an example of the present disclosure;

FIG. 2 is a view illustrating a purge type pressure swing adsorption (PSA) process according to an example of the present disclosure;

FIG. 3 is a view illustrating a comparative moisture removal process using a capture gas;

FIG. 4 is a view illustrating a comparative moisture removal process using a purging gas;

FIG. 5 is a flowchart illustrating a method for removing moisture in a membrane-based carbon dioxide capture system according to an example of the present disclosure;

FIG. 6 is a flowchart illustrating a purging gas control method using waste heat captured through a heat exchanger according to an example of the present disclosure;

FIG. 7 is a flowchart illustrating a purging gas control method using waste heat captured by a heat exchanger according to another example of the present disclosure;

FIGS. 8A and 8B illustrate a purging gas changing procedure in a membrane-based carbon dioxide capture system according to an example of the present disclosure;

FIG. 9 is a view illustrating a purging gas change time according to an embodiment of the present disclosure;

FIGS. 10A and 10B are a view illustrating a purge type thermal swing adsorption (PTSA) method using waste heat that is present in the system according to an example of the present disclosure;

FIG. 11 illustrates a purge type PSA process sequence and a purge type PTSA process sequence according to an example of the present disclosure;

FIGS. 12A, 12B, and 12C are views of a procedure for purging a residual gas and filling a capture gas in a purge type PTSA method according to an example of the present disclosure;

FIG. 13 illustrates performances of moisture adsorption rates of a purge type PSA method and a purge type PTSA method according to an example of the present disclosure; and

FIG. 14 illustrates a computing device according to an example of the present disclosure.

### DETAILED DESCRIPTION

Hereinafter, some examples of the present disclosure will be described in detail with reference to the accompanying drawings. In the drawings, the same reference numerals will be used throughout to designate the same or equivalent components. In describing examples of the present disclosure, detailed descriptions associated with well-known functions or configurations will be omitted if they may make subject matters of the present disclosure unnecessarily obscure.

In describing components of examples of the present disclosure, the terms first, second, A, B, (a), (b), and the like may be used herein. These terms are only used to distinguish one element from another element, but do not limit the corresponding elements irrespective of the nature, order, or priority of the corresponding elements.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as "A, B, or C", "at least one of A, B, and C", "at least one of A, B, or C", etc. as used herein may mean each listed item or all possible combinations of the listed items. For example, "at least one of A or B" may refer to (1) at least one A; (2) at least one B; or (3) at least one A and at least one B. “One or more of” is synonymous with “at least one of” herein.

Unless otherwise defined, the terms used herein, including technical or scientific terms, may have meanings generally understood by those skilled in the art to which the present disclosure belongs.

The expressions such as "comprise", "may comprise", "include", "may include", "have", "may have", etc. as used herein are intended to mean the presence of a characteristic (e.g., function, operation, component, etc.) and do not exclude the presence of other additional characteristics. That is, these expressions should be understood as open-ended terms that encompass the possibility that other examples are included.

A singular expression used herein may include the meaning of the plural unless otherwise stated in the context, which also applies to the singular expression described in the claims.

Unless otherwise defined, all terms including technical and scientific terms used herein are to be interpreted as is customary in the art to which the present disclosure belongs. Such terms as those defined in a generally used dictionary are to be interpreted as having meanings equal to the contextual meanings in the relevant field of art, and are not to be interpreted as having ideal or excessively formal meanings unless clearly defined as having such in the present application.

The expression "based on" as used herein is intended to describe one or more factors that influence an act or operation of determining or deciding described in a phrase or sentence including that expression, and this expression does not exclude any additional factors that influence the act or operation of determining or deciding.

When it is described that a component (e.g., a first component) is "connected" or "coupled" to another component (e.g., a second component) as used herein, it may mean that the component is not only directly connected or coupled to another component, but also connected or coupled through yet another component (e.g., a third component).

Depending on the context, the expression "configured to" as used herein may have meanings such as "set to", "with the ability to", "modified to", "made to", "to be able to", etc. This expression is not limited to the meaning of "specially designed in hardware to". For example, a processor configured to perform a specific operation may refer to a generic purpose processor capable of performing the specific operation by executing software, or to a special purpose computer structured through programming to perform the specific operation.

A control circuitry described herein may comprise circuitry configured to communicate with one or more devices/components (e.g., controllable/switchable valves) or sensors to control one or more functions and/or operations in charge. The control circuitry may be implemented via one or more processors and/or a memory storing an operation system, a logic command, and input/output information, and/or one or more processors performing determination, calculation, and decision necessary for controlling the function in charge. A control circuitry may include, for example, a processor, a central processing unit (CPU), a microchip, a logic, an application-specific integrated circuit (ASIC), memory, etc. A controller may manipulate and/or control other components in the system (e.g., valves, compressors, heat exchangers, etc.).

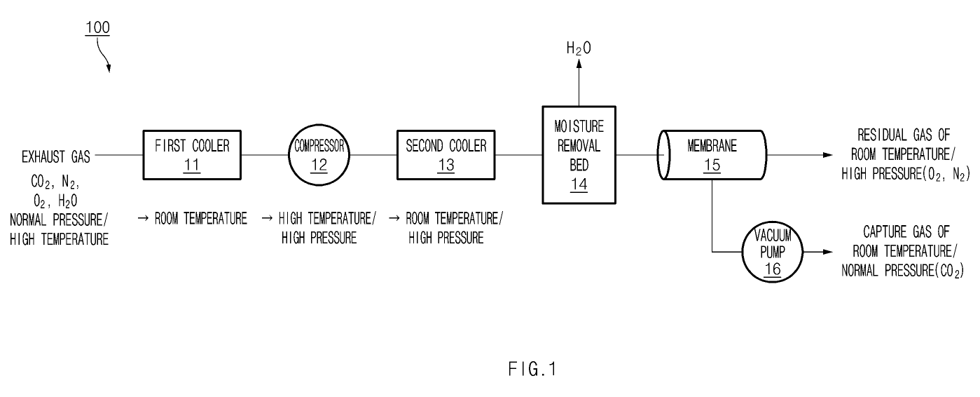

Hereinafter, examples of the present disclosure will be described in detail with reference to FIGS. 1-13.

FIG. 1 is a view illustrating a schematic configuration of a membrane-based carbon dioxide capture system according to an example of the present disclosure.

Referring to FIG. 1, a membrane-based carbon dioxide capture system 100 may include a first cooler 11, a compressor 12, a second cooler 13, a moisture removal bed 14, a membrane 15, and a vacuum pump 16.

Carbon dioxide (CO₂), nitrogen (N₂), oxygen (O₂), and/or moisture (H₂O) may be the main components of exhaust gas of high temperature/normal (e.g., atmospheric) pressure exhausted after combustion in various industrial processes.

The first cooler 11 may cool the exhaust gas of high temperature/atmospheric pressure to a moderate (e.g., room, reduced) temperature, and the compressor 12 may compress the cooled exhaust gas of the atmospheric pressure/moderate temperature to output the exhaust gas of high temperature/high pressure. For example, the exhausted gas may be exhausted at a first pressure and first temperature. The cooler may cool the exhaust gas at the first temperature (the high temperature) and first pressure (e.g., atmospheric pressure) to a second temperature (e.g., room temperature), less than the first temperature, at the first pressure. The compressor may compress the exhaust gas at the second temperature and first pressure to a second pressure, greater than the first pressure. Compressing the exhaust gas may increase the temperature to third temperature (e.g., a high temperature, which may be the same as or different from the first temperature).

The second cooler 13 may cool the exhaust gas of the high temperature/high pressure to generate exhaust gas of a moderate temperature/high pressure. For example, the second cooler 13 may cool the exhaust gas at the third temperature and second pressure to a fourth temperature (e.g., a moderate temperature, which may be lower than the third temperature, and, in an example, higher than the second temperature). The second cooler 13 may supply the gas at the moderate temperature/high pressure (e.g., fourth temperature/second pressure) to the moisture removal bed 14.

After separating and discharging moisture contained in the exhaust gas, the moisture removal bed 14 may supply the exhaust gas, from which the moisture has been removed, to the membrane 15. When/if the moisture contained in the exhaust gas is condensed on the surface of the membrane 15, the condensate may interfere with membrane permeation of carbon dioxide gas and/or cause problems, such as equipment corrosion and freezing damage during winter. Such problems may be avoided/reduced by removing the moisture from the exhaust gas before the exhaust gas is introduced into the membrane 15.

The membrane 15 may selectively allow permeation of carbon dioxide contained in the exhaust gas (e.g., only carbon dioxide is selectively able to pass through the membrane relative to other exhaust gas components). The carbon dioxide/gas that passes through the membrane 15 may be supplied to the vacuum pump 16. The vacuum pump 16 may capture carbon dioxide under vacuum, and discharge the captured carbon dioxide. The residual gas that is not able to pass through the membrane 15 may be discharged from the membrane. For example, the residual gas may include oxygen and nitrogen of moderate temperature/high pressure (e.g., fourth temperature and second pressure).

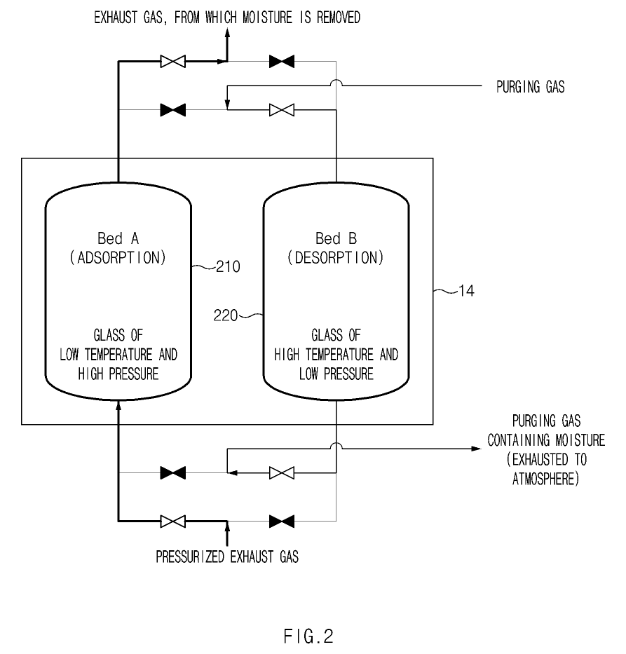

FIG. 2 is a view illustrating a purge type pressure swing adsorption (PSA) process according to an example of the present disclosure.

The purge type PSA process may be used for removing moisture contained in exhaust gas.

As illustrated in FIG. 2, the moisture removal bed 14 applied to the purge type PSA process may include a plurality of beds 210 and 220 containing an adsorbent that adsorbs moisture. Adsorption may be performed at a high pressure by applying pressurized exhaust gas. Desorption may be performed by reducing pressure (e.g., exposing to atmosphere) to decompress, and then flowing the purging gas. Desorption on bed B 220 may be advantageous at a high temperature and a low pressure. Here, a low pressure refers to a state, in which a concentration of moisture, (e.g., a vapor pressure) is low. The purging gas at a high pressure may be a dry gas, (e.g., a moisture-free gas). The purging gas at the high pressure may be advantageous for desorption. A number of the beds may be based on

The purge type PSA process may alternately perform adsorption and desorption (e.g., regeneration) by changing the flows of the exhaust gas and the purging gas. Changing the flows may be controlled by control of valves at regular intervals (e.g., by one or more controllers/control circuitry configured to control operation of the valves). For the purging gas, dry air received from the outside (e.g., external to the carbon dioxide capture system 100 and/or from the moisture removal bed 14) may be used. Also, or alternatively, the residual gas or the capture gas exhausted from the carbon dioxide capture system may be used as the purging gas.

In the case of using external purging gas (e.g., dry air), the process may be simple. However, costs may be incurred due to the use of the external dry air, and/or the concentration of carbon dioxide may be (e.g., temporarily) lowered if the external purging gas is mixed with the exhaust gas. The remaining air in the bed may be injected, after purging, when the adsorption is performed next. Use of the injection of the remaining purging gas with the exhaust gas to capture CO₂ from may cause a temporary degradation and variation of a capture performance (variation in a recovery rate and/or a purity of CO₂) of the membrane.

Using the residual gas (N₂ and O₂) as the purging gas may not require any additional costs for supplying the purging gas. However, as with the use of external purging gas, a temporary degradation of the capture performance due to the residual purging gas left in the bed after the purging may be caused.

Using the capture gas (CO₂) as the purging gas may avoid additional costs for supplying the purging gas, and may avoid a temporary increase in a concentration of carbon dioxide in the capture gas left after the purging occurs. As such, using the capture gas (CO₂) may improve the capture performance of the membrane relative to the use of external purging gas or residual gas without a degradation of the performance. However, a CO₂ recovery rate (captured CO₂/fed CO₂) may be significantly decreased because the captured carbon dioxide is used as the purging gas and is discharged into the atmosphere (e.g., released, not ultimately captured).

A carbon dioxide capture system may produce a lot of waste heat generated by the high-temperature exhaust gas, the compressor, the vacuum pump, and the like. The heat may be wasted if not utilized properly.

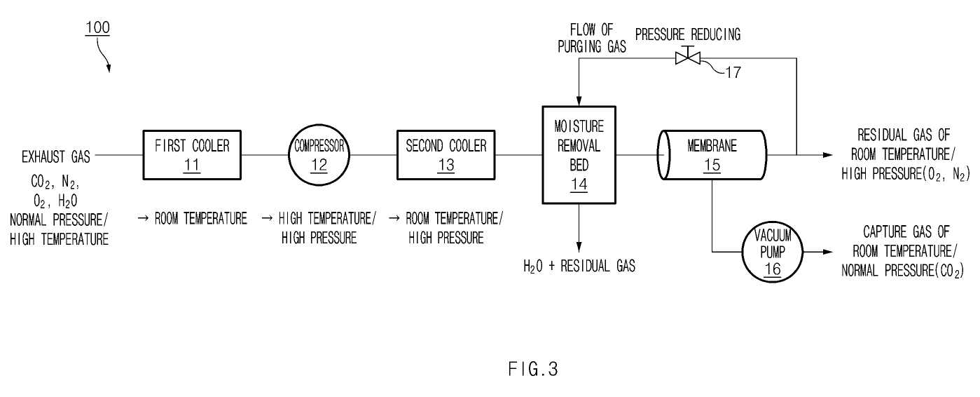

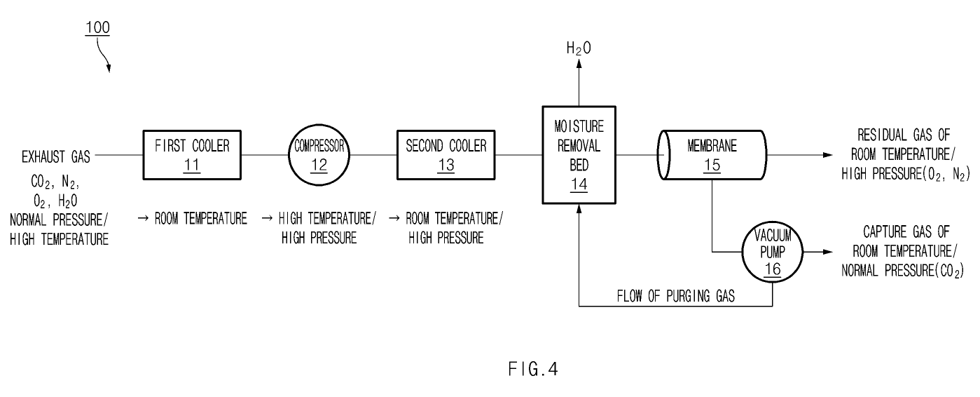

Comparative moisture removal processes will be described with reference to FIGS. 3 and 4.

FIG. 3 is a view illustrating a comparative moisture removal process using a residual gas.

Referring to FIG. 3, the residual gas of the moderate temperature/high pressure discharged through the membrane 15 may be used as a purging gas, and may be decompressed through a pressure reducing valve 17 and then may be supplied to the moisture removal bed 14. As the pressure of the purging gas becomes higher, the purging effect becomes better, and thus, the pressure reducing valve 17 may not be applied. However, if/when the pressure of the purging gas is high enough, it may cause a physical impact on the absorbent and the bed, so the pressure reducing valve 17 may be selectively applied and/or adaptively driven to avoid such impact. The moisture removal bed 14 may discharge the separated moisture and residual gas to the outside of the carbon dioxide capture system 100.

FIG. 4 is a view illustrating a comparative moisture removal process using a purging gas from the vacuum pump.

Referring to FIG. 4, the carbon dioxide captured via the membrane 15 and the vacuum pump 16, that is, the capture gas may be used as the purging gas and may be supplied to the moisture removal bed 14. The moisture removal bed 14 may discharges the separated moisture and residual gas outside of the carbon dioxide capture system 100.

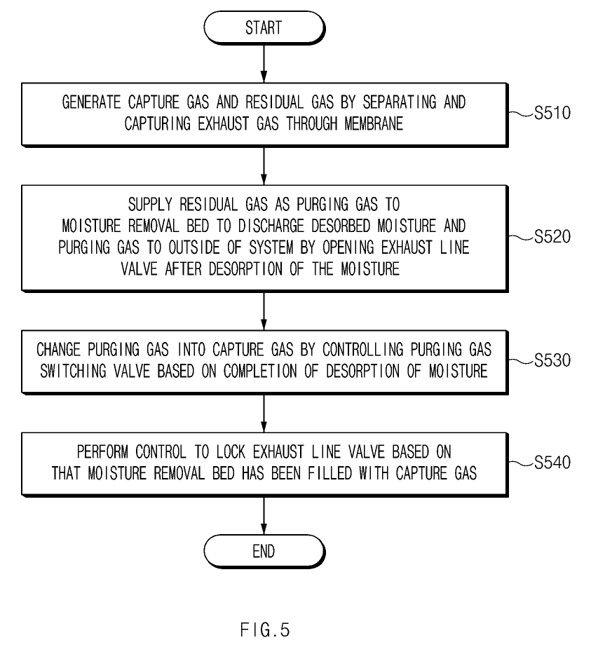

FIG. 5 is a flowchart illustrating a method for removing moisture in a membrane-based carbon dioxide capture system according to an example of the present disclosure. For convenience, FIG. 5 is described by way of an example in which the steps are performed by a processor circuit/control circuitry (e.g., of/associated with the carbon dioxide capture system 100). One, some, or all steps of the example method of FIG. 5, or portions thereof, may be performed by one or more other circuits. One or some, steps of the example method of FIG. 5 may be omitted, performed in other orders, and/or otherwise modified, and/or one or more additional steps may be added.

Referring to FIG. 5, the carbon dioxide capture system 100 may generate the capture gas and the residual gas by separating and capturing the exhaust gas through the membrane 15 (S510).

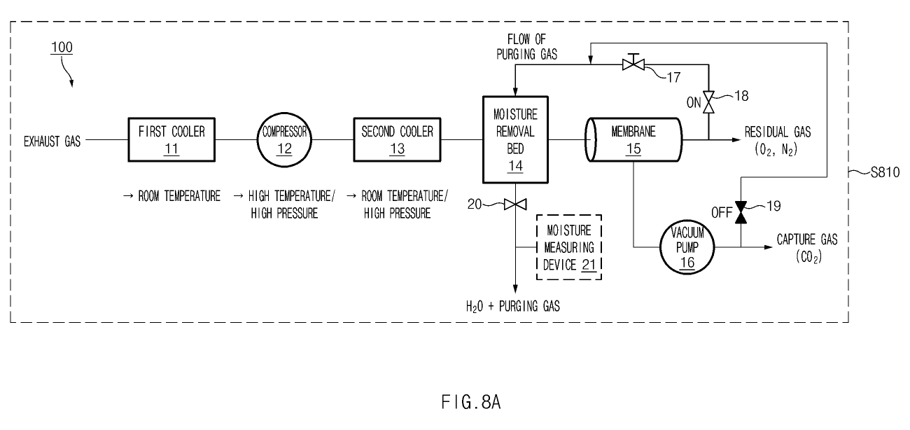

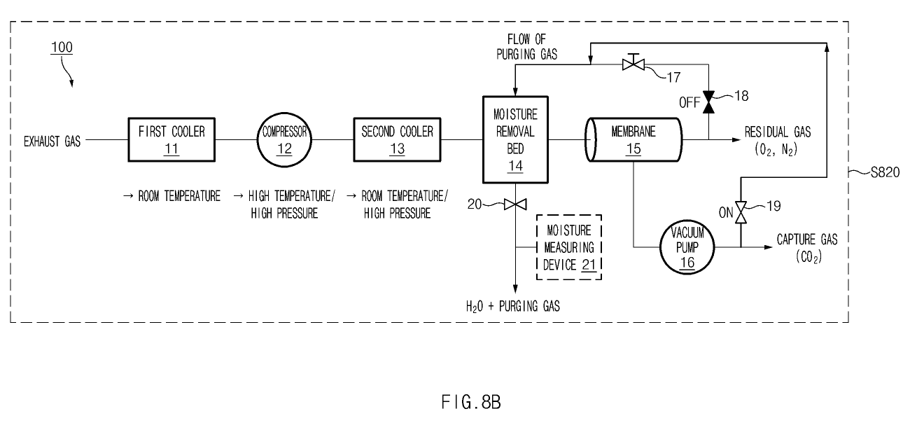

The carbon dioxide capture system 100 may supply the residual gas as a purging gas to the moisture removal bed 14 to discharge the desorbed moisture and purging gas outside of the carbon dioxide capture system 100. For example, the purging gas may be supplied by opening the exhaust line valve after the desorption of the moisture (S520). The exhaust line valve (e.g., exhaust line valve 20, as illustrated in FIGS. 8A-B).

The carbon dioxide capture system 100 may change the purging gas into the capture gas by controlling the purging gas switching valve based on the completion of the desorption of the moisture (S530). The purging gas switching valve may include a first purging gas switching valve 18 and a second purging gas switching valve 19 (e.g., as illustrated in FIGS. 8A-B). That is, as illustrated in operation/configuration 810 of FIG. 8A, the carbon dioxide capture system 10 may open the first purging gas switching valve 18 and close the second purging gas switching valve 19 to supply the residual gas as the purging gas to the moisture removal bed 14. If/when the desorption of the moisture is completed (e.g., as illustrated in operation/configuration 820 of FIG. 8B), the carbon dioxide capture system 100 (e.g., a control circuitry of the carbon dioxide system) may close the first purging gas switching valve 18 and open the second purging gas switching valve to switch the capture gas to the purging gas and supply to the moisture removal bed 14.

The carbon dioxide capture system 100 (e.g., a control circuitry) may perform a control to lock the exhaust line valve (e.g., based on detecting/a determination that the moisture removal bed 14 has been filled with the capture gas) (S540).

The carbon dioxide capture system 100 may open an inlet valve (not illustrated) of the moisture removal bed 14 after locking the purging gas vent line valve (e.g., of FIGS. 8A-B) to continuously supply the exhaust gas to the moisture removal bed to perform the desorption of the moisture.

According to the method of FIG. 5, the present disclosure may solve a problem of the temporary degradation of the capture performance (e.g., which may occur when purging is performed only with the residual gas), and/or a problem of the degradation of a recovery rate of carbon dioxide (e.g., which may occur when purging is performed only with the capture gas). The method of FIG. 5, for example, may improve a performance stability of the membrane-based carbon dioxide capture system.

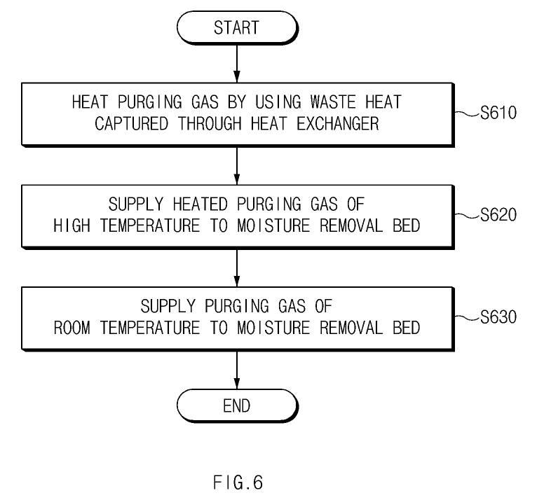

FIG. 6 is a flowchart illustrating a purging gas control method using waste heat captured through a heat exchanger according to an example of the present disclosure. For convenience, FIG. 6 is described by way of an example in which the steps are performed by a processor circuit/control circuitry (e.g., of/associated with the carbon dioxide capture system 100). One, some, or all steps of the example method of FIG. 6, or portions thereof, may be performed by one or more other circuits. One or some, steps of the example method of FIG. 6 may be omitted, performed in other orders, and/or otherwise modified, and/or one or more additional steps may be added.

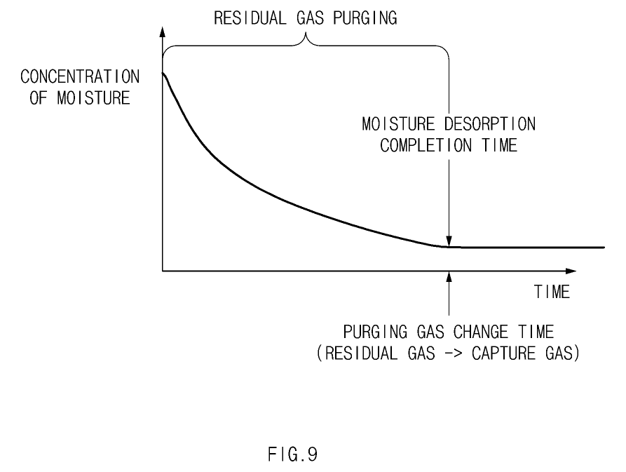

As illustrated in FIGS. 9A-B, the carbon dioxide capture system 100 according to an example may include a heat exchanger 23 and/or 26 that heats the purging gas by using the heat generated in the system. The heat may be generated from the exhaust gas, the compressor 12, the vacuum pump 16, and the like.

Referring to FIG. 6, the carbon dioxide capture system 100 may heat the purging gas by using the heat captured by the heat exchanger (S610).

The carbon dioxide capture system 100 may supply the heated purging gas to the moisture removal bed 14 (S620).

Based on the completion of the desorption of the moisture (e.g., based on detection/a determination of the completion), the carbon dioxide capture system 100 (e.g., a control circuitry of the carbon dioxide capture system 100) may stop supplying the heated purging gas and supply the purging gas of a moderate temperature to the moisture removal bed 14 (S630).

The method of FIG. 6 may improve a moisture removal efficiency and an overall system efficiency by utilizing the waste heat generated in the membrane-based carbon dioxide capturing process.

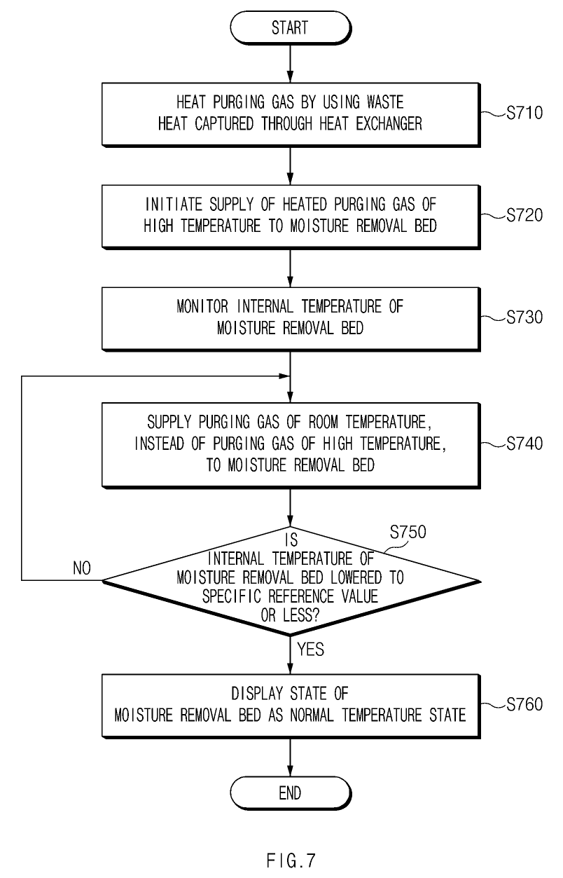

FIG. 7 is a flowchart illustrating a purging gas control method using waste heat captured by a heat exchanger according to another example of the present disclosure. For convenience, FIG. 7 is described by way of an example in which the steps are performed by a processor circuit/control circuitry (e.g., of/associated with the carbon dioxide capture system 100). One, some, or all steps of the example method of FIG. 7, or portions thereof, may be performed by one or more other circuits. One or some, steps of the example method of FIG. 7 may be omitted, performed in other orders, and/or otherwise modified, and/or one or more additional steps may be added.

As illustrated in FIGS. 9A-B, the carbon dioxide capture system 100 according to an example may include a heat exchanger 23 and/or 26 that heats the purging gas by using the waste heat generated in the system, and a temperature measuring device 22 (e.g., temperature sensor, thermometer) that measures an internal temperature of the moisture removal bed 14.

Referring to FIG. 7, the carbon dioxide capture system 100 may heat the purging gas by using the heat captured via the heat exchanger (S710).

The carbon dioxide capture system 100 may initiate supply of the heated purging gas to the moisture removal bed 14 (S720).

The carbon dioxide capture system 100 may monitor an internal temperature of the moisture removal bed 14 by using the provided temperature measuring device 22 (S730) (e.g., temperature sensor, thermometer).

The carbon dioxide capture system 100 may supply the purging gas of a moderate temperature (e.g., instead of the purging gas of a high temperature) to the moisture removal bed (S740).

The carbon dioxide capture system 100 may determine whether the internal temperature of the moisture removal bed 14 satisfies a low threshold temperature condition (e.g., is lowered to a specific reference temperature or less) (S750). If the result of the determination is that the temperature does not satisfy the low threshold temperature condition (S750 - No), the monitoring and supply of purging gas at the moderate temperature (S740).

If the result of the determination is that the temperature does satisfy the threshold temperature condition (S750 - Yes) (e.g., if/when the internal temperature is cooled to the reference value or less), the carbon dioxide capture system 100 may output/display (e.g., via a communication/user interface of the carbon dioxide capture system 100) the internal temperature of the moisture removal bed 14. The communication/user interface may comprise, for example, a light, a lamp, an indicator, a screen, a console, a meter, a gauge, a speaker an LED lamp, a display, and the like (S760).

Through the method of FIG. 7, the present disclosure not only improves a moisture removal efficiency and an overall system efficiency by utilizing waste heat generated in the membrane-based carbon dioxide capturing process, but also prevents deterioration of durability due to overheating of the moisture removal bed 14.

FIGS. 8A-B illustrate a purging gas changing procedure in a membrane-based carbon dioxide capture system according to an example of the present disclosure.

Referring to FIGS. 8A-B, the carbon dioxide capture system 100 according to an example may include a moisture measuring device 21 (e.g., moisture sensor, humidity sensor) that measures a concentration of the moisture contained in the gas discharged through an exhaust line and purging gas switching valves 18 and 19.

The carbon dioxide capture system 100 according to an example may supply residual gas as an initial purging gas to the moisture removal bed 14. In this case, the carbon dioxide capture system 100 may determine whether desorption of the moisture has been completed based on the concentration of the moisture, which is measured by the moisture measuring device 21 (e.g., moisture sensor/humidity sensor).

The carbon dioxide capture system 100 may change the purging gas into the capture gas by controlling the purging gas switching valve. The purging gas may be changed to the capture gas if/when it is determined that the desorption of the moisture has been completed. Here, the purging gas switching valve may include a first purging gas switching valve 18 for supplying the residual gas as a purging gas and a second purging gas switching valve 19 for supplying the capture gas as a purging gas. That is, the carbon dioxide capture system 100 may open the first purging gas switching valve 18 and close the second purging gas switching valve 19 to supply the residual gas as the purging gas to the moisture removal bed 14 as illustrated in operation/configuration 810 of FIG. 8A. The carbon dioxide capture system 100 may close the first purging gas switching valve 18 and open the second purging gas switching valve 19 to switch the capture gas as the purging gas and thus supply the purging gas to the moisture removal bed 14 if/when the desorption of the moisture has been completed, as illustrated in operation/configuration 820 of FIG. 8B.

In an example, a time period required to complete the desorption of the moisture may be measured/determined by basic experimental results in a PSA design stage. The carbon dioxide capture system 100 may determine a purging gas change time, based on the measured/determined moisture desorption time period (e.g., as illustrated in FIG. 9). In another example, the carbon dioxide capture system 100 may measure the concentration of the moisture contained in the gas discharged from the moisture removal bed 14 by using a moisture measuring device 21 (e.g., provided on a side of the purging gas exhaust line). The purging gas change time may be determined to be a time that the measured concentration of the moisture becomes a specific reference value or less as a time, at which point the desorption of moisture is deemed completed.

The carbon dioxide capture system 100 may open an exhaust line valve 20 (and/or the purging gas vent line valve) when/if the capture gas starts to be supplied to the moisture removal bed 14. The exhaust line valve 20 may be opened to discharge all of the residual gas left in the bed. The carbon dioxide capture system 100 may complete the filling and close the exhaust line valve 20 when/if the capture gas completely fills the adsorption bed 210. The residual gas may be expelled/released/pushed out to the atmosphere. The capture gas may be allowed to flow to the bed to fill the bed, in which the desorption of the moisture has been completed with the residual gas. For example, the amount of the residual gas pushed out to the atmosphere may be the same as the amount of the filled capture gas (e.g., replaced by the filled capture gas). Furthermore, the process of filling the adsorption bed 210 with the capture gas, an amount of which corresponds to the amount of the residual gas discharged to the atmosphere (to the outside of the system) may be controlled by the time period, for which the exhaust line valve 20 is closed (e.g., by keeping the exhaust line valve 20 closed).

The time period required to completely fill the capture gas in the adsorption bed 210 may be determined based on the flow rate of the capture gas and the volume of the bed. For example, when the flow rate of the capture gas for purging is 50 Nm3/h and the void volume of the bed is 200 Nm3, the capture gas may be completely filled by allowing the capture gas to flow to the moisture removal bed 14 for only four hours + (margin).

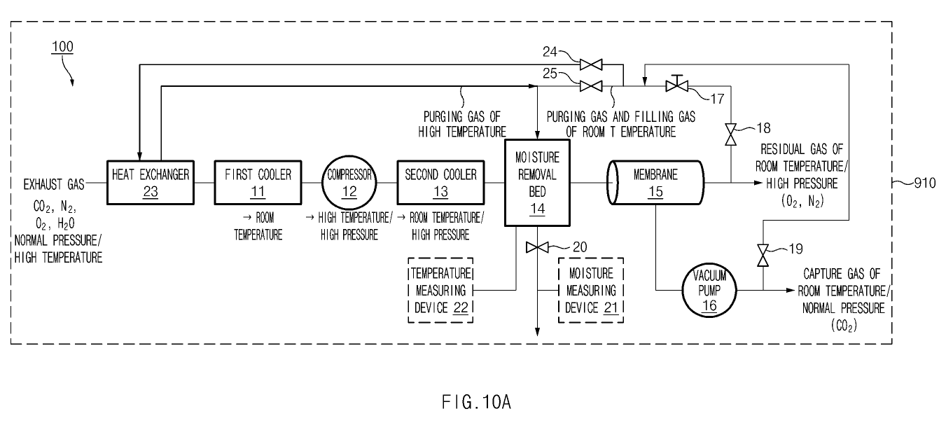

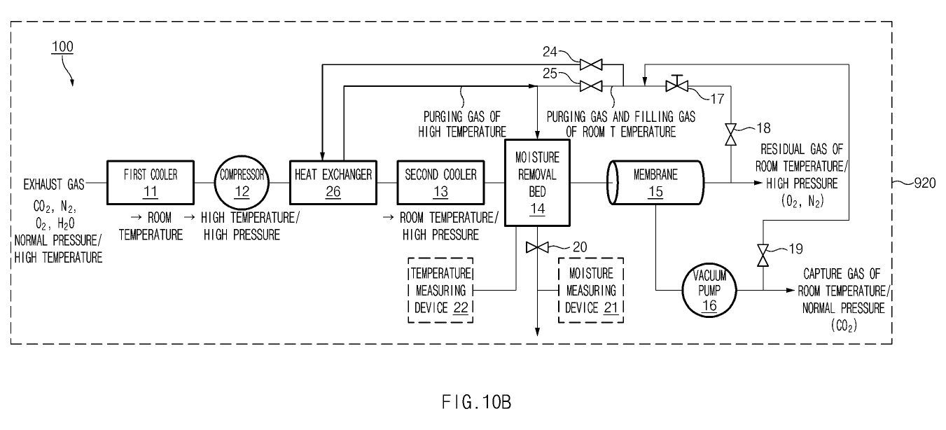

FIGS. 10A-10B a purge type PTSA method using waste heat in the system according to an example of the present disclosure.

Referring to FIGS. 10A-10B, the heat exchangers 23 and 26 may heat the purging gas by utilizing the heat that is present in the system 100. For example, as illustrated in FIG. 10A as operation/configuration 910, one or more of the heat exchanger 23 may be disposed at a front end of the first cooler 11, so as to use the heat of the exhaust gas. Also, or alternatively, as illustrated in FIG. 10B as operation/configuration 920, one or more of the heat exchangers 26 may be disposed at a rear end of the compressor 12 to utilize the heat generated in the compressor 12.

The carbon dioxide capture system 100 according to the PTSA method may convert the purging gas of a moderate temperature into a high temperature via the heat exchangers 23 and/or 26 and supply the high temperature purging gas to the moisture removal bed 14. For example, the internal temperature of the moisture removal bed 14 may increase due to the purging gas of a high temperature. Based on the internal temperature of the moisture removal bed 14 (e.g., measured by the temperature measuring device 22) satisfying a high temperature condition (e.g., having reached a high-temperature reference value) the carbon dioxide capture system 100 may perform a control (e.g., send one or more control signals herein) such that the purging gas of a moderate temperature is supplied to the moisture removal bed 14. The control may be via a specific valve control. The present disclosure prevents/reduces the deterioration of durability of elements of the carbon dioxide capture system 100 (e.g., the moisture removal bed 14, the membrane 15) due to the overheating of the moisture removal bed 14 and/or may prevent overheating by using the purging gas of a moderate temperature efficiently without using a separate cooler for lowering the internal temperature of the moisture removal bed 14.

The temperature measuring device 22 may be installed in the adsorption bed 210 (e.g., to be able to measure a temperature in the adsorption bed 210) in the moisture removal bed 14.

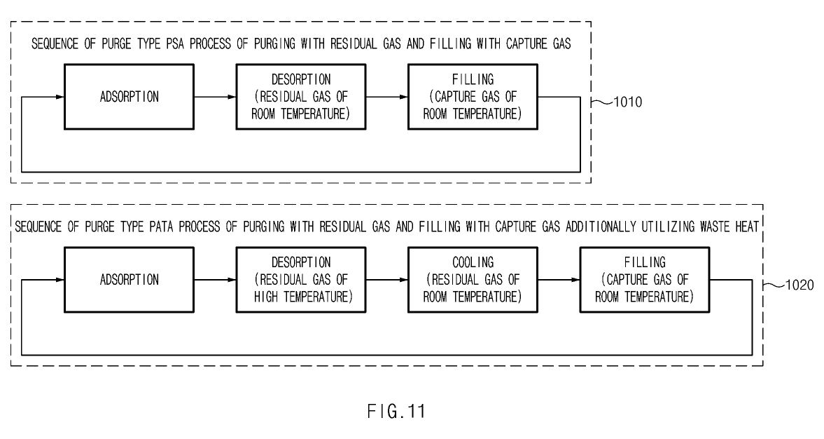

FIG. 11 illustrates a purge type pressure swing adsorption (PSA) process sequence 1010 and a purge type pressure thermal swing adsorption (PTSA) process sequence 1020 according to an example of the present disclosure.

Referring to PSA process sequence 1010 for purging using the residual gas and performing filling with the capture gas, an adsorption operation, a desorption operation with the residual gas of a moderate temperature, and a filling operation with the capture gas of a moderate temperature may be repeatedly sequentially performed.

Referring to PTSA process sequence 1020 for purging with the residual gas and performing filling with the capture gas while additionally utilizing system heat, an adsorption operation, a desorption operation using the residual gas of a high temperature, a cooling operation using the residual gas of a moderate temperature, and a filling operation using the capture gas of a moderate temperature may be repeatedly sequentially performed.

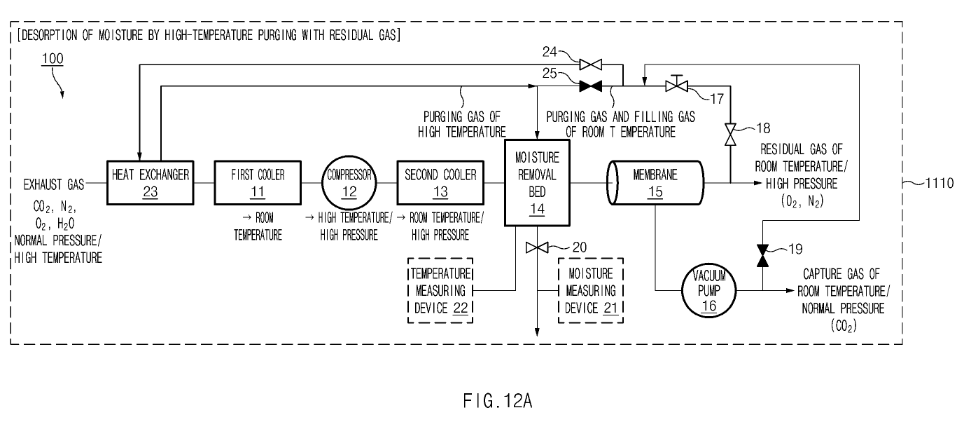

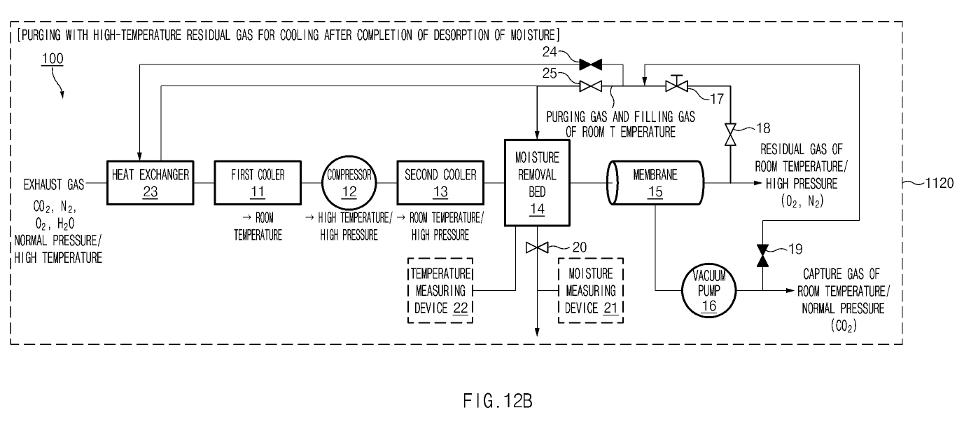

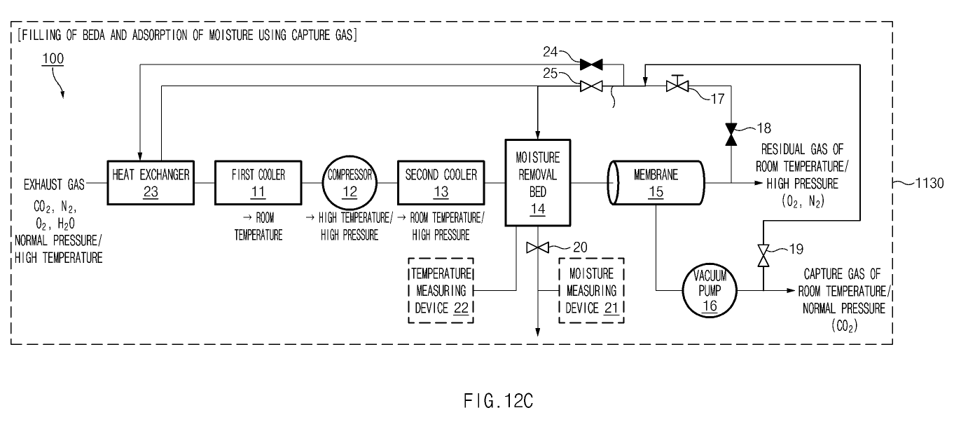

FIGS. 12A to 12C are views of a procedure for purging a residual gas and filling a capture gas in a purge type PTSA method according to an example of the present disclosure.

Operation/configuration 1110 of FIG. 12A illustrates a desorption operation with the residual gas of a high temperature, which may be supplied to the moisture removal bed 14 after the residual gas of a moderate temperature is converted into the purging gas of a high temperature by the heat exchanger 23.

Operation/configuration 1120 of FIG. 12B illustrates a moderate temperature residual gas cooling operation of lowering the temperature of the moisture removal bed 14 by supplying the residual gas of a moderate temperature as the purging gas to the moisture removal bed 14 if/when the temperature, measured by the temperature measuring device 22, is more than the specific reference value.

Operation/configuration 1130 of FIG. 12C illustrates a moderate temperature capture gas filling operation of supplying the capture gas of a moderate temperature to the moisture removing bed 14 to fill it by controlling the purging gas switching valves 18 and 19 based on the desorption of the moisture having been completed.

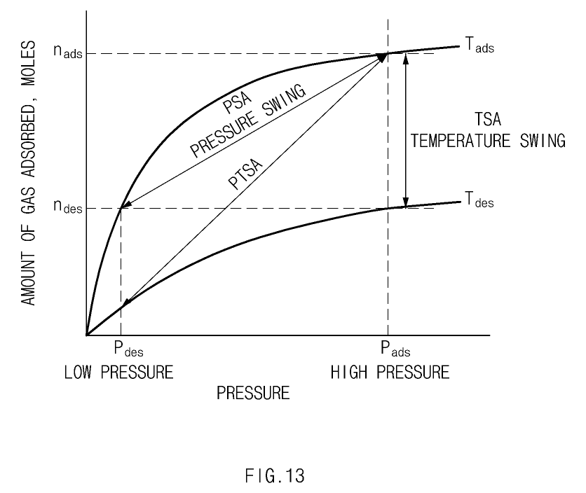

FIG. 13 illustrates performances of moisture adsorption rates of a purge type PSA method and a purge type PTSA method according to an example of the present disclosure.

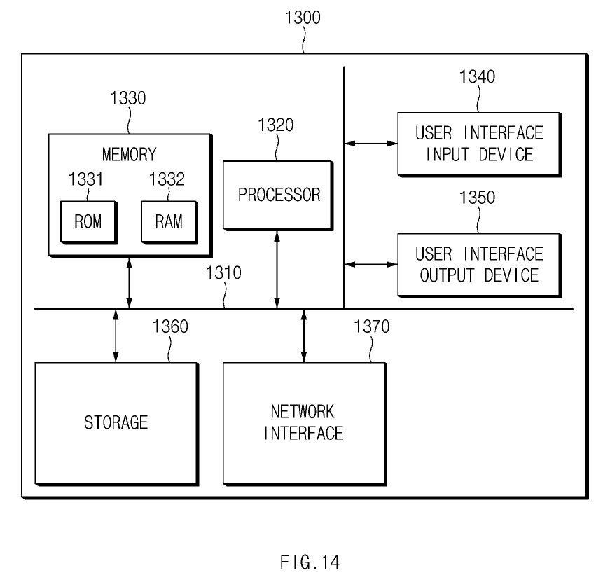

FIG. 14 illustrates a computing device according to an example of the present disclosure. The control circuitry disclosed herein may comprise a computing device, such as the disclosed computing device 1300.

Referring to FIG. 14, a computing device/system 1300 may include at least one of at least one processor 1320, a memory 1330, a user interface input device 1340, a user interface output device 1350, a storage 1360, and a network interface 1370, which are connected to each other through a bus 1310.

The user interface input device 1340 and the user interface output device 1350 may provide a user interface for input/output with an external diagnostic device (not illustrated) and/or a system monitoring device (not illustrated).

The network interface 1370 may provide a communication means for transmitting and receiving control signals between internal components of the carbon dioxide capture system 100 and/or from an external device (e.g., control signals from a control circuitry of or external two the carbon dioxide capture system 100).

The processor 1320 may be a central processing unit (CPU) or a semiconductor device that processes instructions stored in the memory 1330 and/or the storage 1360. The memory 1330 and the storage 1360 may include various types of volatile or nonvolatile storage media. For example, the memory 1330 may include a read only memory (ROM) 1331 and a random access memory (RAM) 1332.

Thus, the operations of the methods (or procedures) or algorithms described in connection with the examples disclosed in the specification may be directly implemented with a hardware module, a software module, or a combination of the hardware module and the software module, which may be executed by the processor 1320. The software module may reside on a storage medium (e.g., the memory 1330 and/or the storage 1360). The storage medium may comprise, for example, a RAM, a flash memory, a ROM, an erasable programmable ROM (EPROM), an electrically EPROM (EEPROM), a register, a hard disc, a removable disk, and a compact disc ROM (CD-ROM). As an example, the processor 1320 may constitute a part of the above-described membrane-based carbon dioxide capture system 100.

The storage medium may be coupled to the processor 1320, and the processor 1320 may read out information from the storage medium and may write information in the storage medium. Alternatively, the storage medium may be integrated with the processor 1320. The processor and the storage medium may reside in an application specific integrated circuit (ASIC). The ASIC may reside in the carbon dioxide capturing apparatus.

The present disclosure provides a method for removing moisture at a high efficiency in a membrane-based carbon dioxide capture system, and an apparatus therefor.

Another aspect of the present disclosure provides a method for removing moisture at a high efficiency in a carbon dioxide capture system, by which residual gas and capture gas are alternately used as a purging gas for removing moisture adsorbed in an adsorbent for removing moisture so that costs may be reduced and moisture may be removed at a high efficiency, and an apparatus therefor.

Another aspect of the present disclosure provide a method for removing moisture at a high efficiency in a carbon dioxide capture system, by which an energy efficiency and a moisture removal efficiency of an entire system may be maximized by expediting desorption of moisture through an increase in a temperature of a purging gas utilizing waste heat generated in a carbon dioxide separation and capture process, and an apparatus therefor.

The technical problems to be solved by the present disclosure are not limited to the problems mentioned herein.

A method for removing moisture in a membrane-based carbon dioxide capture system according to an aspect of the present disclosure may include producing capture gas and residual gas by separating and capturing exhaust gas through a membrane, supplying the residual gas as a purging gas to a moisture removal bed to desorb moisture, and then discharging the desorbed moisture and the residual gas left in the moisture removal bed to an outside of a system by opening a purging gas vent line valve, filling the moisture removal bed with the capture gas by controlling a purging gas switching valve based on completion of desorption of the moisture, and locking the purging gas vent line valve based on that the moisture removal bed has been filled with the capture gas.

As an example, the filling of the capture gas in the moisture removal bed by controlling the purging gas switching valve based on the completion of the desorption of the moisture may include filling the moisture removal bed with the capture gas, an amount of which corresponds to an amount of the residual gas discharged to the outside of the system.

As an example, the locking of the purging gas vent line valve based on that the moisture removal bed has been filled with the capture gas may include determining a time period, for which the moisture removal bed is filled with the capture gas, based on a flow rate of the capture gas and a volume of the moisture removal bed, and locking the purging gas vent line valve in correspondence to the determined time period.

As an example, the method may further include locking the purging gas vent line valve, and supplying the exhaust gas to the moisture removal bed by opening an inlet valve of the moisture removal bed to perform the desorption of the moisture.

As an example, the desorption of the moisture may be performed for a first time period, the first time period is determined as a time period consumed to complete the desorption of the moisture by an adsorbent contained in the moisture removal bed through a preliminary experiment.

As an example, the adsorption of the moisture may be performed for a second time period, the second time period is determined based on a flow rate of the supplied capture gas and a volume of the moisture removal bed.

As an example, the number of the moisture removal bed may be determined based on the first and second time periods.

As an example, the system may include a heat exchanger, and the method may further include raising a temperature of the purging gas with waste heat generated in the system through the heat exchanger.

As an example, the method may further include supplying the purging gas of a room temperature, instead of the purging gas of a high temperature through the heat exchanger, to the moisture removal bed based on the completion of the desorption of the moisture.

As an example, the system may include a compressor that compresses the exhaust gas, and the waste heat may be captured by at least one of the exhaust gas and the compressor.

As an example, the system may include a temperature measuring device that measures an internal temperature of the moisture removal bed, and the method may further include identifying whether the internal temperature of the moisture removal bed has been cooled to a specific reference value or less with the purging gas of a room temperature, based on the internal temperature measured by the temperature measuring device.

As an example, the system may include a moisture measuring device provided at one end of the purging gas vent line valve, and the method may further include determining whether the desorption of the moisture has been completed, based on a concentration of the moisture measured by the moisture measuring device.

A computing device including a membrane-based carbon dioxide capture system according to another aspect of the present disclosure may include a processor that executes instructions, and a memory that stores the instructions, the instructions may be implemented to produce capture gas and residual gas by separating and capturing exhaust gas through a membrane, supply the residual gas as a purging gas to a moisture removal bed to desorb moisture, and then discharging the desorbed moisture and the residual gas left in the moisture removal bed to an outside of a system by opening a purging gas vent line valve, fill the moisture removal bed with the capture gas by controlling a purging gas switching valve based on completion of desorption of the moisture, and locking the purging gas vent line valve based on that the moisture removal bed has been filled with the capture gas.

As an example, the processor may perform a control such that the moisture removal bed is filled with the capture gas, an amount of which corresponds to an amount of the residual gas discharged to an outside of the system.

As an example, a time period, for which the moisture removal bed is filled with the capture gas, may be determined based on a flow rate of the capture gas and a volume of the moisture removal bed, and the purging gas vent line valve may be locked in correspondence to the determined time period.

As an example, the processor may lock the purging gas vent line valve, and may supply the exhaust gas to the moisture removal bed by opening an inlet valve of the moisture removal bed to perform the desorption of the moisture.

As an example, the desorption of the moisture may be performed for a first time period, the first time period is determined as a time period consumed to complete the desorption of the moisture by an adsorbent contained in the moisture removal bed through a preliminary experiment.

As an example, the adsorption of the moisture may be performed for a second time period, the second time period is determined based on a flow rate of the supplied capture gas and a volume of the moisture removal bed.

As an example, the number of the moisture removal bed may be determined based on the first and second time periods.

As an example, the system may include a heat exchanger, and the processor may perform a control such that a temperature of the purging gas is raised with waste heat generated in the system through the heat exchanger.

As an example, the processor may perform a control such that the purging gas of a room temperature, instead of the purging gas of a high temperature through the heat exchanger, is supplied to the moisture removal bed, based on completion of desorption of the moisture.

As an example, the system may include a compressor that compresses the exhaust gas, and the waste heat may be captured by at least one of the exhaust gas and the compressor.

The system may include a temperature measuring device that measures an internal temperature of the moisture removal bed, and the processor may identify whether the internal temperature of the moisture removal bed has been cooled to a specific reference value or less with the purging gas of a room temperature, based on the internal temperature measured by the temperature measuring device.

As an example, the system may include a moisture measuring device provided at one end of the purging gas vent line valve, and the processor may determine whether the desorption of the moisture has been completed, based on a concentration of the moisture measured by the moisture measuring device.

The present disclosure provides a method for removing moisture at a high efficiency in a carbon dioxide capture system, by which residual gas and capture gas are alternately used as a purging gas for removing moisture adsorbed in an adsorbent for removing moisture so that costs may be reduced and moisture may be removed at a high efficiency, and an apparatus therefor.

In addition, the present disclosure provide a method for removing moisture at a high efficiency in a carbon dioxide capture system, by which an energy efficiency and a moisture removal efficiency of an entire system may be maximized by expediting desorption of moisture through an increase in a temperature of a purging gas utilizing waste heat generated in a carbon dioxide separation and capture process, and an apparatus therefor.

In addition, the technology has the advantage of improving the performance stability of the membrane-based carbon dioxide capture system by solving both the temporary capture performance degradation problem that occurs when purging with only the residual gas and the carbon dioxide recovery rate degradation problem that occurs when purging with the conventional residual gas alone.

Besides, a variety of effects directly or indirectly understood through the present disclosure may be provided.

The above description is merely an example of the technical idea of the present disclosure, and various modifications and variations may be made by one skilled in the art without departing from the essential characteristic of the present disclosure.

Accordingly, examples of the present disclosure are intended not to limit but to explain the technical idea of the present disclosure, and the scope and spirit of the present disclosure is not limited by the above examples. The scope of protection of the present disclosure should be construed by the attached claims, and all equivalents thereof should be construed as being included within the scope of the present disclosure.

What is claimed is:

1. A method performed by a carbon dioxide capture system, the method comprising:
separating, via a membrane of the carbon dioxide capture system, exhaust gas into a capture gas and a residual gas, wherein the capture gas comprises carbon dioxide removed via the membrane from the exhaust gas, and the residual gas comprises a residual of the exhaust gas;
supplying, to a moisture removal bed of the carbon dioxide capture system, the residual gas as a purging gas to desorb moisture from the moisture removal bed;
discharging, from the moisture removal bed and to an outside of the carbon dioxide capture system by opening a purging gas vent line valve of the carbon dioxide capture system, moisture desorbed from the moisture removal bed and a portion of the residual gas in the moisture removal bed;
based on desorption of moisture from the moisture removal bed being completed, filling, by controlling a purging gas switching valve, the moisture removal bed with the capture gas; and
locking, based on the moisture removal bed being filled with the capture gas, the purging gas vent line valve.

2. The method of claim 1, wherein the filling the moisture removal bed with the capture gas comprises filling the moisture removal bed an amount of the capture gas that corresponds to an amount of the residual gas discharged from the moisture removal bed.

3. The method of claim 1, wherein the locking of the purging gas vent line valve comprises locking the purging gas vent line valve in correspondence with a time period, wherein the time period is set based on:
a flow rate of the capture gas, and
a volume of the moisture removal bed.

4. The method of claim 1, further comprising:
opening an inlet valve of the moisture removal bed to supply the residual gas to the moisture removal bed.

5. The method of claim 1, wherein the supplying of the residual gas as the purging gas is performed for a first time period sufficient to complete the desorption of the moisture from an adsorbent contained in the moisture removal bed, the method further comprising:
maintaining the capture gas filled in the moisture removal bed for adsorption of the moisture for a second time period based on a flow rate of the capture gas and a volume of the moisture removal bed.

6. The method of claim 1, further comprising raising, via a heat exchanger of the carbon dioxide capture system and using heat generated by the carbon dioxide capture system, a temperature of the purging gas.

7. The method of claim 6, further comprising:
cooling, via the heat exchanger, the purging gas before supplying the purging gas to the moisture removal bed.

8. The method of claim 6, further comprising compressing, via a compressor of the carbon dioxide capture system, the exhaust gas, and
wherein the heat is generated by at least one of the exhaust gas or the compressor.

9. The method of claim 1, further comprising:
determining, after beginning the supplying the residual gas as the purging gas and based on an internal temperature of the moisture removal bed measured by a temperature sensor of the carbon dioxide capture system, whether the internal temperature of the moisture removal bed satisfies a temperature threshold.

10. The method of claim 1, further comprising determining, based on a measurement, by a moisture sensor, of a concentration of moisture in gas discharged from the moisture removal bed, whether the desorption of the moisture from the moisture removal bed has been completed.

11. A computing device associated with a carbon dioxide capture system, the computing device comprising:
a processor configured to execute instructions; and
a memory configured to store the instructions, wherein the instructions, when executed by the processor, are configured to cause the carbon dioxide capture system to:
separate, via a membrane of the carbon dioxide capture system, exhaust gas into a capture gas and a residual gas, wherein the capture gas comprises carbon dioxide removed via the membrane from the exhaust gas, and the residual gas comprises a residual of the exhaust gas,
supply, to a moisture removal bed of the carbon dioxide capture system, the residual gas as a purging gas to desorb moisture from the moisture removal bed,
discharge, from the moisture removal bed and to an outside of the carbon dioxide capture system by opening a purging gas vent line valve of the carbon dioxide capture system, moisture desorbed form the moisture removal bed and a portion of the residual gas in the moisture removal bed,
based on desorption of moisture from the moisture removal bed being completed, fill, by controlling a purging gas switching valve, the moisture removal bed with the capture gas, and
lock based on the moisture removal bed being filled with the capture gas, the purging gas vent line valve.

12. The computing device of claim 11, wherein the instructions, when executed by the processor, are configured to cause the carbon dioxide capture system to:
fill the moisture removal bed with the capture gas for a time period based on a flow rate of the capture gas and a volume of the moisture removal bed, and
lock the purging gas vent line valve in correspondence with the time period.

13. The computing device of claim 11, wherein the instructions, when executed by the processor, are configured to cause the carbon dioxide capture system to:
open an inlet valve of the moisture removal bed to supply the residual gas to the moisture removal bed.

14. The computing device of claim 11, wherein the instructions, when executed by the processor, are configured to cause the carbon dioxide capture system to:
supply the residual gas as the purging gas for a first time period sufficient to complete the desorption of the moisture from an adsorbent contained in the moisture removal bed, and
maintain the capture gas filled in the moisture removal bed for adsorption of the moisture for a second time period based on a flow rate of the capture gas and a volume of the moisture removal bed.

15. The computing device of claim 11, wherein the instructions, when executed by the processor, are configured to cause the carbon dioxide capture system to raise, via a heat exchanger of the carbon dioxide capture system and using heat generated by the carbon dioxide capture system, a temperature of the purging gas.

16. The computing device of claim 15, wherein the instructions, when executed by the processor, are configured to cause the carbon dioxide capture system to:
cool, via the heat exchanger, the purging gas before the purging gas is supplied to the moisture removal bed.

17. The computing device of claim 15, wherein the instructions, when executed by the processor, are configured to cause the carbon dioxide capture system to:
compress, via a compressor of the carbon dioxide capture system, the exhaust gas, wherein the heat is generated by at least one of the exhaust gas or the compressor.

18. The computing device of claim 11, wherein the computing device is configured to control the carbon dioxide capture system to:
determine, after beginning the supplying the residual gas as the purging gas and based on an internal temperature of the moisture removal bed measured by a temperature sensor of the carbon dioxide capture system, whether the internal temperature of the moisture removal bed satisfies a temperature threshold.

19. The computing device of claim 11, wherein the instructions, when executed by the processor, are configured to cause the carbon dioxide capture system to:
determine, based on a measurement, by a moisture sensor, of a concentration of moisture in gas discharged from the moisture removal bed, whether the desorption of the moisture from the moisture removal bed has been completed.

20. A carbon dioxide capture system comprising:
a membrane configured to selectively allow passage of carbon dioxide;
a moisture removal bed configured to adsorb moisture from a gas;
a purging gas vent line valve configured to open or lock a purging gas vent line;
a purging gas switching valve configured to switch a source of gas to the moisture removal bed; and
control circuitry configured to control the carbon dioxide capture system to:
separate, via the membrane, exhaust gas into a capture gas and a residual gas, wherein the capture gas comprises carbon dioxide removed from the exhaust gas, and the residual gas comprises a residual of the exhaust gas;
supply, to the moisture removal bed, the residual gas as a purging gas to desorb moisture from the moisture removal bed;
discharge, from the moisture removal bed by opening the purging gas vent line valve, moisture desorbed form the moisture removal bed and a portion of the residual gas in the moisture removal bed;
based on a determination that desorption of moisture from the moisture removal bed being completed, fill, by controlling the purging gas switching valve, the moisture removal bed with the capture gas; and
lock, based on the moisture removal bed being filled with the capture gas, the purging gas vent line valve.
